(19) United States
(12) Patent Application Publication
(10) Pub. No.: US 2012/0144181 A1
(43) Pub. Date: Jun. 7, 2012

(54) MOTHERBOARD AND METHOD FOR DISPLAYING HOST SYSTEM PARAMETER

(75) Inventor: Chih-Shien Lin, Taipei (TW)

(73) Assignee: ASUSTek COMPUTER INC., Taipei (TW)

(21) Appl. No.: 13/311,758

(22) Filed: Dec. 6, 2011

(30) Foreign Application Priority Data
Dec. 7, 2010 (TW) 099142679

(51) Int. Cl. G06F 15/177

(52) U.S. Cl. 713/2

(57) ABSTRACT

A motherboard and a method for displaying a host system parameter are provided. The motherboard includes a bridge circuit receiving the host system parameter, a microcontroller connected to the bridge circuit, and a transmitter connected to the microcontroller. The microcontroller is capable of directly capturing the host system parameter from the bridge circuit and then transmitting the system parameter to the transmitter when the motherboard is powered on.

This application claims the benefit of Taiwan application Serial No. 99142679, filed Dec. 7, 2010, the subject matter of which is incorporated herein by reference.

### BACKGROUND OF THE INVENTION

1. Field of the Invention

The invention relates to a motherboard and a parameter display method thereof.

2. Description of the Related Art

Computer system is very important in modern information society. The computer system integrates multiple circuits (such as a chip or various peripheral devices) with different functions together at a motherboard to achieve an overall function. Operation states and parameters of the circuits are reflected in the host system parameters of the computer system.

For example, when the computer system boots up, a basic input/output system (BIOS) of the computer system executes a power on self-test (POST) to test each of the circuits of the computer system in sequence, and the testing process and results are reflected at the host system parameters.

Since the host system parameters reflect the operation state of the computer system, the host system parameters should be displayed to a user to show the operation state of the computer system. For example, when the computer system cannot boot up normally, the user can get that which circuit of the computer system has a problem via the host system parameters.

However, when the computer system boots up, if a circuit cannot operate normally and results in an interruption in booting before a display circuit operates, the computer system cannot display any information on a display.

### BRIEF SUMMARY OF THE INVENTION

A motherboard includes a bridge circuit receiving a host system parameter, a microcontroller connected to the bridge circuit, and a transmitter connected to the microcontroller. When the motherboard is powered on, the microcontroller directly captures the host system parameter from the bridge circuit and transmits the host system parameter to the transmitter.

A computer system includes a display and a motherboard connected to the display. The motherboard further includes a bridge circuit receiving host system parameters, a microcontroller connected to the bridge circuit, and a transmitter connecting the microcontroller and the display. When the motherboard is powered on, the microcontroller directly captures the system parameter from the bridge circuit and transmits the host system parameter to the transmitter, and the host system parameter from transmitter to the display is displayed on the display.

A method for displaying a host system parameter applied to a computer system is also disclosed. The computer system includes a motherboard and a display. The motherboard includes a bridge circuit and a microcontroller. The method includes following steps: booting up the computer system to generate the host system parameter to the bridge circuit; capturing the host system parameter from the bridge circuit directly via the microcontroller; and displaying the host system parameter on the display.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional computer system; and

FIG. 2 is a schematic diagram showing a motherboard applied to a computer system in an embodiment.

### DETAILED DESCRIPTION OF THE EMBODIMENTS

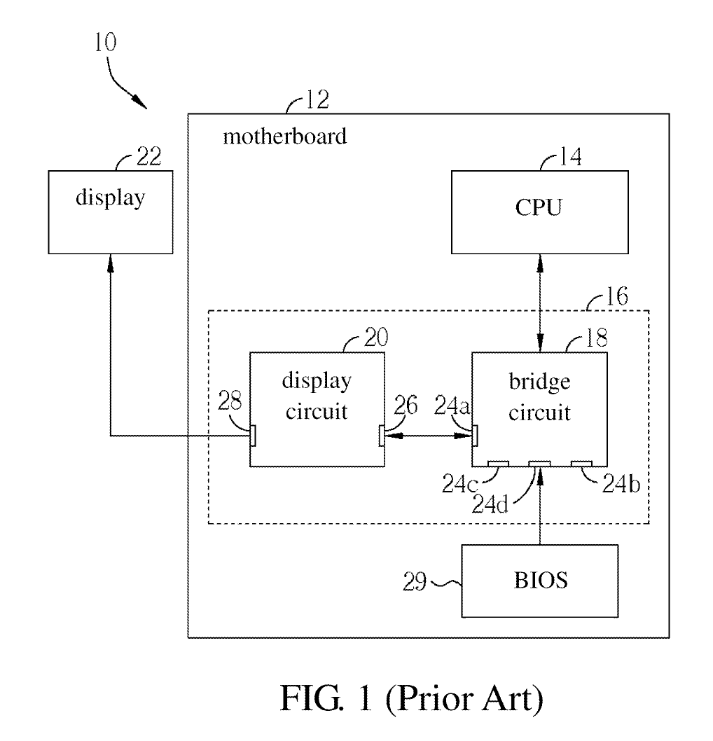

FIG. 1 is a schematic diagram showing a conventional motherboard 12 applied to a computer system 10. The motherboard 12 includes a central processing unit (CPU) 14, a kernel module 16 and a BIOS 29. The kernel module 16 includes a bridge circuit 18 and a display circuit 20. The CPU 14 calculates, processes information and controls the operation of the computer system 10.

The bridge circuit 18 includes a plurality of interface ports 24a to 24d as shown in FIG. 1. The bridge circuit 18 is connected to the CPU 14 via a front bus for bridging the CPU 14 and the interface ports 24a to 24d. Each of the interface ports 24a to 24d may be an I/O interface of different specifications and is coupled to different circuits or peripheral devices of the computer system 10. For example, the interface port 24a is coupled to the display circuit 20, and the interface port 24d is coupled to the BIOS 29. Other interface ports (such as the interface ports 24b and 24c) may be I/O interfaces of peripheral component interconnect (PCI), PCI-express (PCI-E), advanced technology attachment (ATA), serial ATA (SATA) or universal serial bus (USB) specification for coupling to a memory, a network card, an audio card, a hard disk, an optical disk drive (ODD), a printer, a keyboard, a mouse or other peripheral devices.

The display circuit 20 is responsible for calculating and processing for image display of the computer system 10. The display circuit 20 includes an interface port 26 and a display port 28. The interface port 26 is coupled to the corresponding interface port 24a of the bridge circuit 18, and the display port 28 is used as a video interface and coupled to a display 22.

The BIOS 29 is coupled to the interface port 24d of the bridge circuit 18. When the computer system 10 boots up, the BIOS 29 executes a POST to test each of the circuits (such as the circuits or peripheral devices coupled to the interface ports 24a to 24d) of the computer system in sequence and reflects the testing process and results at the host system parameters. The host system parameters may be recorded in the bridge circuit 18 and can be accessed via the interface port.

Since the POST does not test the display circuit 20 at the beginning, if other circuits cannot operate normally and result in an interruption in booting before the display circuit 20 operates, the computer system 10 cannot display any information at the display 22, and the user cannot get the reason of the abnormal booting.

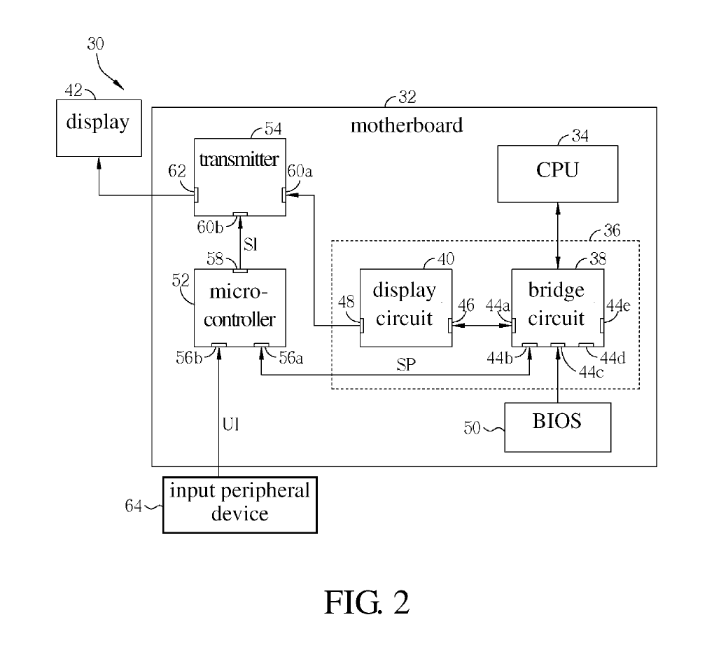

FIG. 2 is a schematic diagram showing a motherboard 32 applied to a computer system 30 in an embodiment. The computer system 30 further includes a display 42 and an input peripheral device 64. The motherboard 32 includes a CPU 34, a kernel module 36 and a BIOS 50. The motherboard 32 further includes a microcontroller 52 and a transmitter 54.

The kernel module 36 includes a bridge circuit 38 and a display circuit 40. The CPU 34 does calculations and data processing, executes an operation system and various software programs, and controls the operation of the computer system 30.

The bridge circuit 38 can achieve a south bridge function, and it also be integrated with a north bridge function. The bridge circuit 38 includes a plurality of interface ports. The interface ports 44a to 44e are taken as an example in FIG. 2. The bridge circuit 38 is coupled to the CPU 34 via a front bus for bridging the CPU 34 and the interface ports 44a to 44e. The interface ports 44a to 44e may be I/O interfaces of different specifications and coupled to other circuits or peripheral devices of the computer system 30. For example, the interface port 44a, 44b and 44c are coupled to the display circuit 40, the microcontroller 52 and the BIOS 50, respectively. Other interface ports (such as the interface ports 44d and 44e) may be I/O interfaces of PCI, PCI-E, ATA, SATA or USB specification for coupling to a memory, a network card, an audio card, a hard disk, an ODD, a printer, a keyboard, a mouse or other peripheral devices.

The display circuit 40 is responsible for calculating and processing for image display of the computer system 30. The display circuit 40 includes an interface port 46 and a display port 48. The interface port 46 is coupled to the corresponding interface port 44a of the bridge circuit 38 for receiving data to be displayed. The display port 48 is used as a video interface, such as a video graphics array (VGA), a digital visual interface (DVI) or a high definition multimedia interface (HDMI).

The BIOS 50 is coupled to the interface port 44c of the bridge circuit 38. When the computer system 30 boots up, the BIOS 50 executes a POST to test each of the circuits (such as the circuits or peripheral devices coupled to the interface ports 44a to 44e) of the computer system in sequence and reflects the testing process and results at the host system parameters SP.

The microcontroller 52 includes a control interface 56a and a transmission interface 58. The control interface 56a is coupled to the interface port 44b to receive the host system parameters SP from the bridge circuit 38 and sends corresponding system information SI via the transmission interface 58 according to the host system parameters SP.

The transmitter 54 includes two input ports 60a and 60b (a first input port and a second input port) and an output port 62. The input port 60a is coupled to the display port 48 of the display circuit 40, and the input port 60b is coupled to the transmission interface 58 of the microcontroller 52 for receiving the system information SI. The transmission interface 58 may be coupled to the input port 60b via an I/O interface such as an inter-integrated circuit (12C), a universal asynchronous receive/transmitter (UART) or a serial peripheral interface (SR).

The output port 62 of the transmitter 54 is used as a video interface and is coupled to a display 42 to display the system information SI and signals from the display port 48 on the display 42 via the OSD. For example, the video interface of the display port 48 may be an interface of VGA, a DVI or a HDMI.

As stated above, the microcontroller 52 gets the host system parameters SP and transmits them to the transmitter 54 to display the host system parameters SP on the display 42. Due to the cooperation of the microcontroller 52 and the transmitter 54, when the BIOS 50 executes the POST, no matter whether the display circuit 40 operates normally or not, the host system parameters SP can be displayed at the display 42 via the transmitter 54. For example, the process and the results of the POST are both displayed on the display 42.

When the computer system 30 finishes booting and loading the operation system and starts to operate, the image that the CPU 34 executes the operation system interface is carried at the signal of the display port 48 via the display circuit 40, and the signal is transmitted to the transmitter 54. The transmitter 54 transmits the signal to display at the display 42. The host system parameters SP may be overlapped at the operation system interface via the OSD, and thus both of the host system parameters SP and the image of the operation system interface can be displayed to the user at the same time. For example, the host system parameters SP may include pulse frequency, operation temperature and operation voltage of the computer system 30, and all of the parameters can be displayed at the display 42 truly without software support of the operation system. Since the display function of the display 42 is powerful, the transmitter 54 may present the host system parameters SP via pictures, colors, letter symbols, flash and so on.

In FIG. 2, the microcontroller 52 further includes an input interface 56b for receiving an input operation UI of the user to allow the microcontroller 52 to set or change the host system parameters SP of the computer system 30 actively according to the input operation UI. For example, the control interface 56a is used to set the pulse frequency or the operation voltage of a relating circuit. The input interface 56b may be an I/O interface of USB, PS/2, Bluetooth, infrared ray (IR) or Wi-Fi specification and coupled to an input peripheral device 64 for receiving the input operation UI from the input peripheral device 64. For example, the input peripheral device 64 may be a keyboard, a mouse or a touchpad.

In the embodiment, the computer system 30 not only displays the host system parameters SP, and it also allows the user to adjust the host system parameters SP dynamically and real-timely to meet real-time requirements of the user. Moreover, the user may control the operation that the transmitter 54 displays the host system parameters SP via the input peripheral device 64 of the microcontroller 52. For example, whether to display the host system parameters SP or which host system parameters SP to be displayed can be controlled. When the user does not need to check the host system parameters SP, the transmitter 54 stops displaying the host system parameters SP.

In sum, compared to the conventional technology, the OSD is used to display the host system parameters of the computer system on the display to allow the user to know the operation state of the computer system more conveniently and clearly and further to adjust, set, change or update the host system parameters of the computer dynamically.

In FIG. 2, the display circuit 40 may be a display card or be integrated to one chip with the bridge circuit 38. The transmitter 54 and the microcontroller 52 may be two independent chips disposed at the motherboard 32 or be integrated to one chip. The microcontroller 52 may be integrated with the bridge circuit 38. The transmitter 54 may be integrated with the display circuit 40.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A motherboard, comprising:
a bridge circuit receiving a host system parameter;
a microcontroller connected to the bridge circuit; and
a transmitter connected to the microcontroller;
wherein when the motherboard is powered on, the microcontroller directly captures the host system parameter from the bridge circuit and transmits the host system parameter to the transmitter.

2. The motherboard according to claim 1, the motherboard further includes a basic input/output system (BIOS) connected to the bridge circuit, and after the motherboard is powered on, the BIOS executes a power on self-test (POST) to generate the host system parameter.

3. The motherboard according to claim 1, wherein the motherboard further includes a display circuit connecting the bridge circuit and the transmitter.

4. The motherboard according to claim 1, wherein the microcontroller further includes an input interface receiving an input operation to change the host system parameter.

5. The motherboard according to claim 1, wherein the transmitter uses an on screen display (OSD) to display the host system parameter on a display.

6. The motherboard according to claim 1, wherein the bridge circuit is a south bridge chip.

7. A computer system, comprising:
a display; and
a motherboard connected to the display, wherein the motherboard further comprises:
a bridge circuit receiving a host system parameter;
a microcontroller connected to the bridge circuit; and
a transmitter connected to the microcontroller and the display;
wherein when the motherboard is powered on, the microcontroller directly captures the system parameter from the bridge circuit and transmits the host system parameter to the transmitter, and the host system parameter from transmitter to the display is displayed on the display.

8. The computer system according to claim 7, wherein the computer system further includes a BIOS connected to the bridge circuit, and after the computer system is powered on, the BIOS executes a POST to generate the host system parameter.

9. The computer system according to claim 7, wherein the computer system further includes a display circuit connecting the bridge circuit and the transmitter.

10. The computer system according to claim 7, wherein the computer system further includes an input peripheral device connected to the microcontroller, and the input peripheral device generates an input operation to the microcontroller to change the host system parameter.

11. The computer system according to claim 7, wherein the transmitter uses an OSD to display the host system parameter on the display.

12. The computer system according to claim 7, wherein the bridge circuit is a south bridge chip.

13. A method for displaying a host system parameter, applied to a computer system, wherein the computer system includes a motherboard and a display, the motherboard includes a bridge circuit and a microcontroller, the method comprising:
booting up the computer system to generate the host system parameter to the bridge circuit;
capturing the host system parameter from the bridge circuit directly via the microcontroller; and
displaying the host system parameter on the display.

14. The method for displaying the host system parameter according to claim 13, wherein the microcontroller directly captures the host system parameter from the bridge circuit during a POST procedure of the computer system.

15. The method for displaying the host system parameter according to claim 13, wherein computer system further includes an input peripheral device connected to the microcontroller, and the input peripheral device generates an input operation to the microcontroller to change the host system parameter.

16. The method for displaying the host system parameter according to claim 13, wherein the motherboard further includes a transmitter, and the transmitter uses an OSD to display the host system parameter from the microcontroller on the display.
